(19) United States
(12) Patent Application Publication
(10) Pub. No.: US 2014/0347492 A1
(43) Pub. Date: Nov. 27, 2014

(54) VENUE MAP GENERATION AND UPDATING

(71) Applicant: Qualcomm Incorporated, San Diego, CA (US)

(72) Inventor: Mary FALES, San Diego, CA (US)

(73) Assignee: QUALCOMM Incorporated, San Diego, CA (US)

(21) Appl. No.: 13/901,798

(22) Filed: May 24, 2013

(51) Int. Cl. H04N 5/33

(52) U.S. Cl. CPC H04N 5/33
USPC 348/164

(57) ABSTRACT

Image data from cameras can be used to detect structural components and furnishings of a venue using image processing. A venue map can be generated or updated accordingly. Image data may be obtained from existing cameras (e.g., security cameras) and/or specialized cameras (e.g., IR cameras). The updated or generated building map may then be transmitted to a mobile device and/or stored by a server for use by a positioning system.

### BACKGROUND

Positioning systems can utilize various types of information to calculate location of an object. Global Positioning System (GPS) and other like satellite positioning systems have enabled navigation services for mobile handsets in outdoor environments. Since satellite signals may not be reliably received and/or acquired in an indoor environment, different techniques may be employed to enable navigation services. In some implementations, an indoor navigation system may provide a digital electronic map to mobile stations upon entry to a particular indoor area. Such information can include a map of the surroundings of an object, together with movement data or other information. Such a map may show indoor features such as doors, hallways, entry ways, walls, etc., points of interest such as bathrooms, pay phones, room names, stores, etc. Such a digital electronic map may be stored at a server to be accessible by a mobile station through selection of a universal resource locator (URL), for example. By obtaining and displaying such a map, a mobile station may overlay a current location of the mobile station (and user) over the displayed map to provide the user with additional context. Using map information indicating routing constraints, a mobile station may also apply location estimates to estimate a trajectory of the mobile station in an indoor area subject to the routing constraints.

Problems can arise, however, when maps become outdated. Resulting positioning data—and the applications that utilize the positioning data (e.g., navigation)—can become unreliable and the user experience can suffer. Traditional techniques for updating maps can be expensive, manually intensive, and time consuming, as can the creation of the maps initially.

### SUMMARY

Image data from cameras can be used to detect structural components and furnishings of a venue using image processing. A venue map can be generated or updated accordingly. Image data may be obtained from existing cameras (e.g., security cameras) and/or specialized cameras (e.g., IR cameras). The updated or generated building map may then be transmitted to a mobile device and/or stored by a server for use by a positioning system.

An example method of updating a venue map, according to the description, includes obtaining the venue map, obtaining image data from one or more cameras located within the venue, and processing the image data to determine the presence of an object at the venue. The method further includes comparing, with a processor, the venue map with the processed image data, and updating the venue map based on the comparison.

The example method can include one or more of the following features. The image data can be from one or more infrared (IR) cameras. The image data can be from one or more camera images of visible light. Processing the image data can include determining one or more patterns indicative of either or both an item that reflects IR radiation above a certain threshold or, an item that reflects IR radiation below a certain threshold. The object can include at least one of a sticker, paint, a symbol, an IR absorber, an IR reflector, or a tag. The method can include determining the object is attached to a structural component or furnishing of the venue, identifying the object, determining an orientation of the structural component or furnishing based on an orientation of the object, and/or determining one or more features of the structural component or furnishing based on information corresponding to the object. The object can comprise a structural component or furnishing. The method can include sending the venue map to a mobile device.

An example server, according to the description, can include a communication interface, a memory, and a processing unit communicatively coupled with the memory and the communication interface. The processing unit is configured to perform functions including obtaining a venue map, obtaining image data from one or more cameras located within the venue, and processing the image data to determine the presence of an object at the venue. The processing unit is further configured to perform functions including comparing the venue map with the processed image data, and updating the venue map based on the comparison.

The example server of claim can include one or more of the following features. The processing unit can be configured to obtain the image data from one or more visible light cameras and/or from one or more infrared (IR) cameras. The processing unit can be configured to process the image data by determining one or more patterns indicative of either or both an item that reflects IR light above a certain threshold or, an item that reflects IR light below a certain threshold. The processing unit can be configured to determine the presence of an object by determining the presence of at least one of a sticker, paint, a symbol, an IR emitter, or a tag. The processing unit can be further configured to determine the object is attached to a structural component or furnishing of the venue. The processing unit can be further configured to identify the object, determine an orientation of the structural component or furnishing based on an orientation of the object, determine one or more features of the structural component or furnishing based on information corresponding to the object, and/or determine the presence of an object by determining the presence of a structural component or furnishing.

An example computer-readable storage medium, according to the description, can have instructions embedded thereon for updating a venue map, the instructions including computer-executable code for obtaining the venue map, obtaining image data from one or more cameras located within the venue, processing the image data to determine the presence of an object at the venue, and updating the venue map based on the comparison.

The example computer-readable storage medium can include one or more of the following features. The code for processing the image data can comprise code for processing image data from one or more visible-light cameras and/or one or more infrared (IR) cameras. The code for processing the image data can include code for determining one or more patterns indicative of either or both an item that reflects IR light above a certain threshold or, an item that reflects IR light below a certain threshold. The code for determining the presence of an object can include code for determining the presence of at least one of a sticker, paint, a symbol, an IR emitter, or a tag. The computer-readable storage medium can further comprise code for determining the object is attached to a structural component or furnishing of the venue, identifying the object, determining an orientation of the structural component or furnishing based on an orientation of the object, and/or determining one or more features of the structural component or furnishing based on information corresponding to the object. The code for determining the presence of an object can comprise code for determining the presence of a structural component or furnishing. The computer-readable storage medium can further comprise code for sending the venue map to a mobile device.

An example device, according to the description, can include means for obtaining a venue map, means for obtaining image data from one or more cameras located within the venue, means for processing the image data to determine the presence of an object at the venue, means for comparing the venue map with the processed image data, and means for updating the venue map based on the comparison.

The example device can include one or more of the following features. The means for processing the image data can comprise means for processing image data from one or more visible-light cameras and/or one or more infrared (IR) cameras. The means for processing the image data can include means for determining one or more patterns indicative of either or both an item that reflects IR light above a certain threshold or, an item that reflects IR light below a certain threshold. The means for determining the presence of an object can include means for determining the presence of at least one of a sticker, paint, an insignia, an emblem, an IR emitter, or a tag. The device can further comprise means for determining the object is attached to a structural component or furnishing of the venue, identifying the object, determining an orientation of the structural component or furnishing based on an orientation of the object, and/or determining one or more features of the structural component or furnishing based on information corresponding to the object. The device can further comprise means for determining the object comprises a structural component or furnishing and/or sending the venue map to a mobile device.

An example method of generating a venue map, according to the description, can include obtaining image data from one or more cameras located within the venue, processing the image data to determine the presence of an object at the venue, and generating, with a processor, the venue map having a feature based on the determined presence of the object.

The method of generating a venue map can include one or more of the following features. The image data is from one or more camera images of visible light and/or one or more infrared (IR) cameras. The object can include at least one of a sticker, paint, an insignia, an emblem, an IR emitter, or a tag. The method can further comprise determining the object is attached to a structural component or furnishing of the venue, identifying the object, determining an orientation of the structural component or furnishing based on an orientation of the object, and/or determining one or more features of the structural component or furnishing based on information corresponding to the object. The object can comprise a structural component or furnishing. The method can include sending the venue map to a mobile device.

An example server, according to the disclosure, can include a communication interface, a memory, and a processing unit communicatively coupled with the memory and the communication interface. The processing unit is configured to perform functions including obtaining image data from one or more cameras located within a venue, processing the image data to determine the presence of an object at the venue, and generating the venue map having a feature based on the determined presence of the object.

The example server can further include one or more of the following features. The processing unit can be configured to obtain the image data from one or more visible light cameras and/or one or more infrared (IR) cameras. The processing unit can be configured to determine the presence of an object by determining the presence of at least one of a sticker, paint, an insignia, an emblem, an IR emitter, or a tag. The processing unit can be further configured to determine the object is attached to a structural component or furnishing of the venue, identify the object, determine an orientation of the structural component or furnishing based on an orientation of the object, and/or determine one or more features of the structural component or furnishing based on information corresponding to the object. The object can comprise a structural component or furnishing. The processing unit can be further configured to send the venue map to a mobile device via the communication interface.

An example computer-readable storage medium, according to the disclosure, can have instructions embedded thereon for generating a venue map. The instructions include computer-executable code for obtaining image data from one or more cameras located within a venue, processing the image data to determine the presence of an object at the venue, and generating the venue map having a feature based on the determined presence of the object.

The example computer-readable storage medium can further include one or more of the following features. The code for processing the image data can comprise code for processing image data from one or more visible-light cameras and/or one or more infrared (IR) cameras. The code for determining the presence of an object can comprise code for determining the presence of at least one of a sticker, paint, an insignia, an emblem, an IR emitter, or a tag. The computer-readable storage medium can comprise code for determining the object is attached to a structural component or furnishing of the venue, identifying the object, determining an orientation of the structural component or furnishing based on an orientation of the object, and or determining one or more features of the structural component or furnishing based on information corresponding to the object. The object can comprise a structural component or furnishing. The computer-readable storage medium can comprise code for sending the venue map to a mobile device.

An example device, according to the disclosure, can include means for obtaining image data from one or more cameras located within a venue, means for processing the image data to determine the presence of an object at the venue, and means for generating the venue map having a feature based on the determined presence of the object.

The example device can include one or more of the following features. The means for processing the image data can comprise means for processing image data from one or more visible-light cameras and/or one or more infrared (IR) cameras. The means for processing the image data to determine the presence of an object can comprise means for determining the presence of at least one of a sticker, paint, an insignia, an emblem, an IR emitter, or a tag. The device can further comprise means for determining the object is attached to a structural component or furnishing of the venue, identifying the object, determining an orientation of the structural component or furnishing based on an orientation of the object, and/or determining one or more features of the structural component or furnishing based on information corresponding to the object. The object can comprise a structural component or furnishing. The device can further comprise means for sending the venue map to a mobile device.

Items and/or techniques described herein may provide one or more of the following capabilities, as well as other capabilities not mentioned. Techniques can provide for cost savings through automatic map creation and/or updating. Embodiments can also utilize easily-implementable image processing techniques to determine object features. These and other embodiments, along with many of its advantages and features, are described in more detail in conjunction with the text below and attached figures.

### BRIEF DESCRIPTION OF THE DRAWINGS

FIG. 1 is a simplified illustration of a positioning system, according to one embodiment.

FIG. 2 is an example representation of a portion of a map.

FIGS. 3A-3B are a simplified drawings (or map) of a subsection of a room, according to one embodiment.

FIGS. 4A-4B are corresponding IR images (shown in greyscale) of the drawings of 3A and 3B.

FIG. 5 is a grayscale histogram of the image shown in FIG. 4B.

FIGS. 6A and 6B are black and white representations of FIG. 4B with different histogram thresholds.

FIG. 7 illustrates the view of a portion of a room from a ceiling-mounted camera.

FIG. 8 is a simplified input/output diagram illustrating inputs and outputs of a map generation/updating engine, according to one embodiment.

FIG. 9 is a flow chart of a method for processing an IR image, according to one embodiment.

FIG. 10 is a flow diagram of a method for updating a venue map, according to one embodiment.

FIG. 11 is a flow diagram of a method for generating venue map, according to one embodiment.

FIG. 12 is a block diagram illustrating an embodiment of a computer system.

### DETAILED DESCRIPTION

The following description is provided with reference to the drawings, where like reference numerals are used to refer to like elements throughout. While various details of one or more techniques are described herein, other techniques are also possible. In some instances, structures and devices are shown in block diagram form in order to facilitate describing various techniques.

“Instructions” as referred to herein relate to expressions which represent one or more logical operations. For example, instructions may be “machine-readable” by being interpretable by a machine for executing one or more operations on one or more data objects. However, this is merely an example of instructions and claimed subject matter is not limited in this respect. In another example, instructions as referred to herein may relate to encoded commands which are executable by a processing unit having a command set which includes the encoded commands. Such an instruction may be encoded in the form of a machine language understood by the processing unit. Again, these are merely examples of an instruction and claimed subject matter is not limited in this respect.

Different techniques may be used to estimate the location of a mobile device such as a cell phone, personal digital assistant (PDA), tablet computer, personal media player, gaming device, and the like, according to the desired functionality of the mobile device. For example, some mobile devices may process signals received from a Satellite Positioning System (SPS) to estimate their locations for navigation, social media location information, location tracking, and the like.

Positioning systems can additionally or alternatively utilize wireless signals (e.g., Wi-Fi) from access points to locate a mobile device (e.g., mobile phone, tablet, etc.) in or around buildings, where SPS signals may not be reliable. The positioning systems can further utilize software, executed by the mobile device and/or a server, that examines building maps to more accurately pinpoint a mobile device within a building. These maps can be costly and time consuming to create. Even more problematic, they can become outdated when there are changes to the building structure or movement of objects such as furniture and shelving within or around the building.

An outdated map can cause difficulties, for example, when a navigation application uses location data from the positioning system to guide a mobile device user through a shopping mall. The outdated map may show a wall or door that is not currently there or may attempt to route the user through shelving that was not indicated on the map. The outdated map could incorrectly route a user to a desired object or location that is no longer there. For example, a user upon entering a mall may want to navigate to a kiosk based on outdated map data, but that kiosk may have been moved since the creation of the outdated map. Thus, the navigation system would route the user to the wrong place. These types of events can result in a poor user experience, and the user may not feel they can rely on the navigation application. Existing solutions to automatically create and update building maps involve crowdsourcing location information from mobile devices, but this can be slow, processing intensive, and subject to errors. Embodiments of the present invention, however, can automatically create and update building maps inexpensively by using image data from cameras.

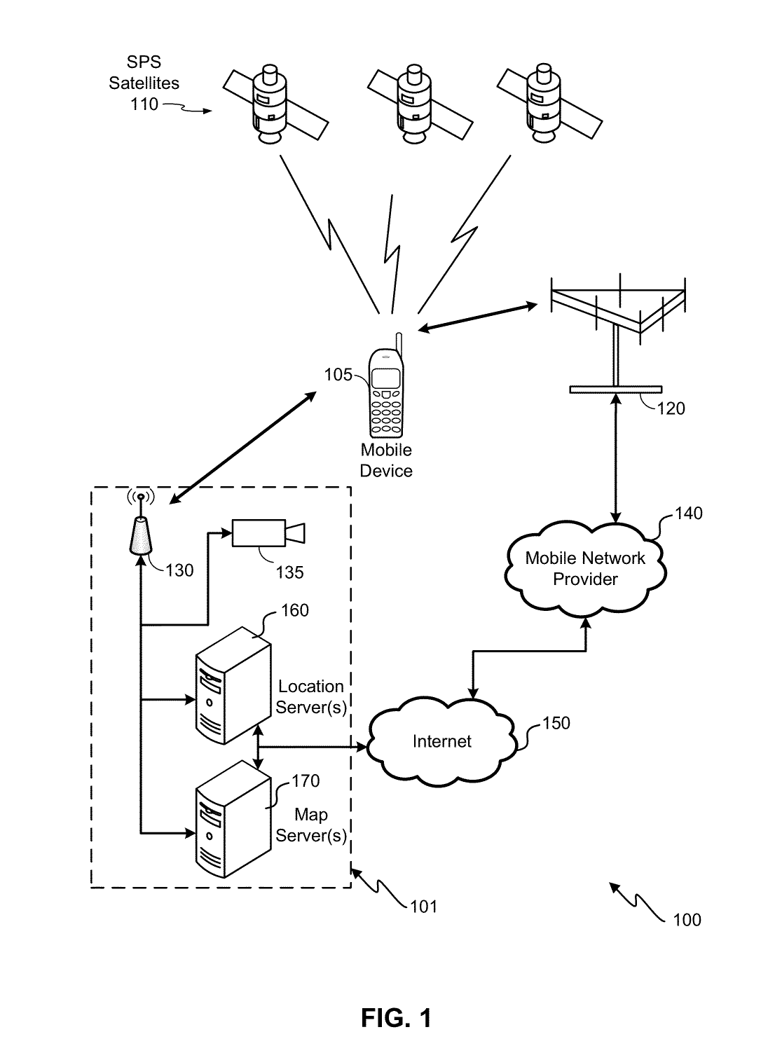

FIG. 1 is a simplified illustration of a positioning system 100, according to one embodiment. The positioning system can include a mobile device 105, SPS satellites, base transceiver station(s) 120, mobile network provider 140, access point(s) 130, camera(s) 135, location server(s) 160, map server(s) 170, and the Internet 150. It should be noted that FIG. 1 provides only a generalized illustration of various components, any or all of which may be utilized as appropriate. Furthermore, components may be combined, separated, substituted, and/or omitted, depending on desired functionality. A person of ordinary skill in the art will recognize many modifications to the components illustrated.

In the positioning system 100, a location of the mobile device 105 can be determined any of a variety of ways. In some embodiments, for example, the location of the mobile device 105 can be calculated using triangulation and/or other positioning techniques with information transmitted from SPS satellites 110. Satellite positioning systems may include such systems as the Global Positioning System (GPS), Galileo, Glonass, Compass, Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems.

Embodiments may also use communication and/or positioning capabilities provided by base transceiver stations 120 and mobile network provider 140 (e.g., a cell phone service provider), as well as access point(s) 130. Communication to and from the mobile device 105 may thus also be implemented, in some embodiments, using various wireless communication networks. The mobile network provider 140, for example, can comprise such as a wide area wireless network (WWAN). The access point(s) 130 can be part of a wireless local area network (WLAN), a wireless personal area network (WPAN), and the like. The term “network” and “system” may be used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMax (IEEE 802.16), and so on. A CDMA network may implement one or more radio access technologies (RATs) such as cdma2000, Wideband-CDMA (W-CDMA), and so on. Cdma2000 includes IS-95, IS-2000, and/or IS-856 standards. A TDMA network may implement Global System for Mobile Communications (GSM), Digital Advanced Mobile Phone System (D-AMPS), or some other RAT. An OFDMA network may implement Long Term Evolution (LTE), LTE Advanced, and so on. LTE, LTE Advanced, GSM, and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may also be an IEEE 802.11x network, and a WPAN may be a Bluetooth network, an IEEE 802.15x, or some other type of network. The techniques described herein may also be used for any combination of WWAN, WLAN and/or WPAN.

Mobile network provider 140 and/or access point(s) 130 can further communicatively connect the mobile device 105 to the Internet 150. Other embodiments may include other networks in addition, or as an alternative to, the Internet 150. Such networks can include any of a variety of public and/or private communication networks, including wide area network (WAN), local area network (LAN), and the like. Moreover, networking technologies can include switching and/or packetized networks utilizing optical, radio frequency (RF), wired, satellite, and/or other technologies.

A subset 101 of the components of the positioning system 100 can utilize access point(s) 130 and maps for positioning. This can be especially useful in and around buildings, where positioning with SPS satellites 110 and/or base stations 120 may not be accurate or reliable. Although only one subset 101 is shown, many subsets 101 can be utilized in a positioning system 100 (e.g., one subset per building, campus, etc.). Moreover, in some embodiments, the positioning system 100 may not include SPS and/or base station 120 positioning components. Thus, in some embodiments, the subset 101 may be the entirety of the positioning system 100. For example, venues (such as shopping malls, retail stores, transit stations, stadiums, office buildings, and the like) may employ the subset 101 as a stand-alone positioning system.

Access point(s) 130 of the positioning system can be used for wireless voice and/or data communication with the mobile device 105, as well as independent sources of position data, e.g., through implementation of trilateration-based procedures based on measurements (e.g., round-trip time (RTT), received signal strength indication (RSSI), and the like). The access point(s) 130 can be part of a WLAN that operates in a building to perform communications over smaller geographic regions than a WWAN. The access point(s) 130 can be part of a WiFi network (802.11x), cellular piconets and/or femtocells, Bluetooth network, and the like. The access point(s) 130 can also form part of a Qualcomm® indoor positioning system (QUIPS™). Embodiments may include any number of access point(s) 130, any of which may be a moveable node, or may be otherwise capable of being relocated.

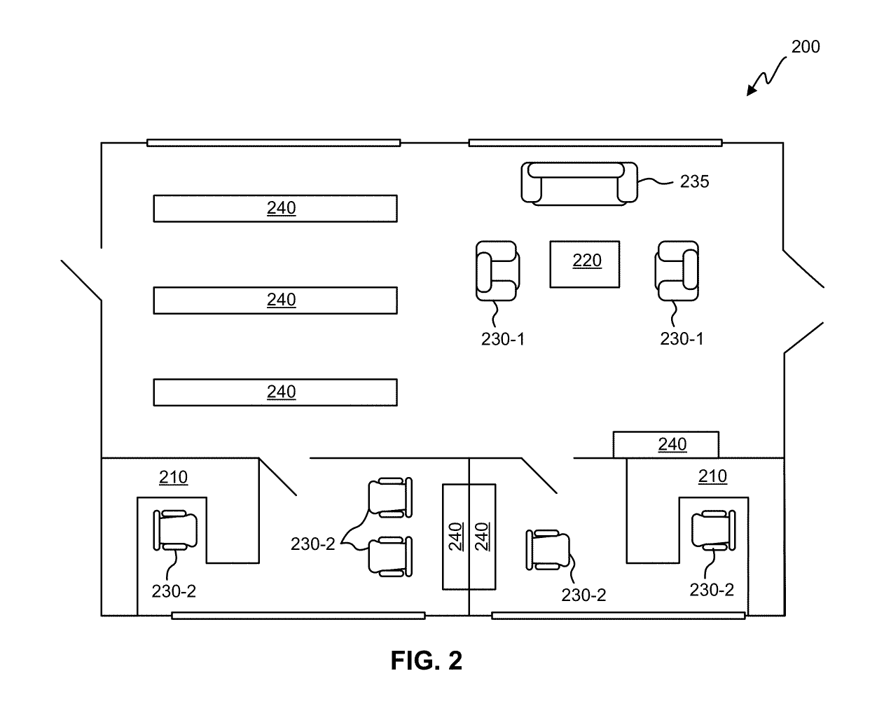

To facilitate positioning determinations, map server(s) 170 can provide location information such as maps, motion models, context determinations, and the like, which can be used by the location server(s) 160 and/or mobile device 105 to determine a location of the mobile device 105. In some embodiments, for example, map server(s) 170 associated with a building can provide a map to a mobile device 105 when the mobile devices approaches and/or enters the building. The map (also referred to herein as “map data”), can comprise an electronic representation of a layout of the building (indicating physical features such as walls, doors, windows, etc.). As discussed in more detail below, embodiments can utilize camera(s) 135 to generate and/or update map data based on object detection. The map data can be sent to the mobile device 105 from the map server(s) 170 via the access point(s) 130, and/or via the Internet 150, mobile network provider 140, and base transceiver station(s) 120. FIG. 2 is an example representation of a portion 200 of a map.

As illustrated, map data not only can include immovable features such as windows, doors, and walls, but can also contain information regarding structural components and furnishings such as desks 210, tables 220, chairs 230 couches 235, bookcases 240 (and/or other shelving), and the like, including objects not shown, such as checkout counters, sales displays, exhibits, etc. Map data may even include location information regarding frequently-moved objects, such as the smaller chairs 230-2 illustrated in FIG. 2 (as opposed to larger chairs 230-1 that are less subject to being moved around). As indicated previously, mobile phones and other portable electronic devices can provide navigation and/or functionality based on positioning information, which can include map data.

When tables 220, bookcases 240, and/or other structural components and furnishings are moved, map data becomes outdated and unreliable. Take, for example, the following scenario. An original venue map of a bookstore may have been made at great expense and time and then provided to a mobile device through a server. An application executed by the mobile device can utilize the map to determine current positioning and navigation routes through the bookstore. But because the bookstore changes its internal structures or the furnishings often, the map may likely be outdated. The map may show, for example, a bookcase 240 that may not be currently there, a wall or door that has been removed, etc. In such cases, the navigation for the user is significantly hampered. The user experience is downgraded and the user may not feel they can rely on the navigation application.

To address this problem, map data for venues must be updated. However venue operators often do not have the tools or methods to create updated maps. In fact, some venue operators may even find initial map creation expenses inhibitive. Traditional venue map generation and updating is manual in nature. Typically, a person will input the details and parameters of the map into a computer to create the venue map. But this takes time and is expensive. Automatic map generation using crowdsourcing measurements has been implemented in which a server may gather location data over time from participating mobile devices and determine if a change in the map has occurred. However, this method can be algorithm intensive, it also requires an initial venue map to start with, and can take a long period of time before recognizing changes. It may also be prone to errors. For example, consider a banquet hall in a hotel that has sliding wall partitions or moving book shelves in a library. If users are walking by and creating a map based on crowdsourcing, the map will not be accurate when the movable objects are placed back to their resting locations. Also, to have an accurate map based on crowdsourcing may require a statistical significant portion of data from various mobile devices to consider the mobile source data valid, so when a single or few mobile devices report a change, the server may not accept the data as valid until a statistically significant representation is met and preserve the outdated map. Also, consider that crowdsourcing may provide some path navigation information, but it may not easily provide other object identification as the present embodiments explain further below.

Embodiments of the present invention give a cost-effective solution by providing automatic generation and/or updating of map data for a venue based on camera images. It can be noted that although examples provided herein discuss map data generation and/or updating using infrared (IR) images, embodiments can utilize other and/or additional spectra, including visible light.

Images from security or other cameras installed around a venue can be utilized to identify objects such as building structural components (walls, windows, floors, doors, etc.) and furnishings using image processing techniques, discussed in further detail below. For embodiments in which IR images are to be used, existing visible-light cameras currently used for security can easily be upgraded to cameras capable of capturing IR images. Some embodiments may provide for capturing images and filtering RGB elements to create IR-like images with properties similar to real IR images. These IR-like images can then be image processed the same as real IR images to provide detailed information about the venue and objects. Once the objects are identified, they can be used to create and/or update map data of the venue.

IR images can be particularly useful in object detection. IR emission is related to the radiation of heat. The heat transfer is an electromagnetic wave having wavelengths in the range between visible light and microwave (approximately 430 THz-300 GHz). In other words, IR light has wavelengths like visible light, only it is invisible to the human eye. Near infrared (NIR) is considered to be the closest in wavelength to visible light and far infrared (FIR) is considered to be closest to microwaves. It is the FIR wavelengths that are more sensitive to thermal. NIR wavelengths are not as sensitive to thermal and may be used in medical equipment applications like detecting sugar in blood. Special cameras and sensors capture the heat and assign colors to represent the heat level. Typically, the coolest areas are given the darkest colors and the warmest areas are given the brightest colors.

Using IR (thermal properties) can provide detailed information not otherwise available with a regular camera. Consider a person walking at night. A visible light camera may not be able to capture the image of the person because it is too dark. However, an NIR image that essentially captures heat information along with some light information could capture the image of the man walking. The man will show up as a brighter color than surrounding objects as the man is emitting IR radiation (heat). The man's face may appear white and radiate the most heat while his shoes may appear green, because they are radiating less heat. The appearance of objects in IR images is governed by three basic phenomena: absorption, reflection, and transmission. It therefore follows that, due to the conservation of energy:

Reflection+Absorption+Transmission=100% IR (1)

For purposes of understanding the embodiments, simplified discussion on absorbers and reflectors will be the primary focus.

Objects such as walls, floors, desks, tables, displays, shelving and more are commonly made from a single material (e.g., wood, drywall, cardboard, steel, etc.), and therefore have, roughly speaking, uniform thermal properties. That is, objects made from a single material, or similar materials, have similar IR reflection, absorption, and transmission at certain wavelengths of the infrared spectrum. Some materials have wavelength-dependent absorption properties. In other words, they may absorb near and infrared wavelengths differently than far infrared wavelengths. Also, certain materials like glass may be completely transparent to visible light, but opaque to IR. These unique IR properties can be exploited to detect objects or structural components according to the disclosed embodiments. For example, knowing the IR emittance characteristics of a material can help identify it. Materials that have similar visible colors may be more distinguishable using infrared than visible light, because their infrared absorption properties may be different.

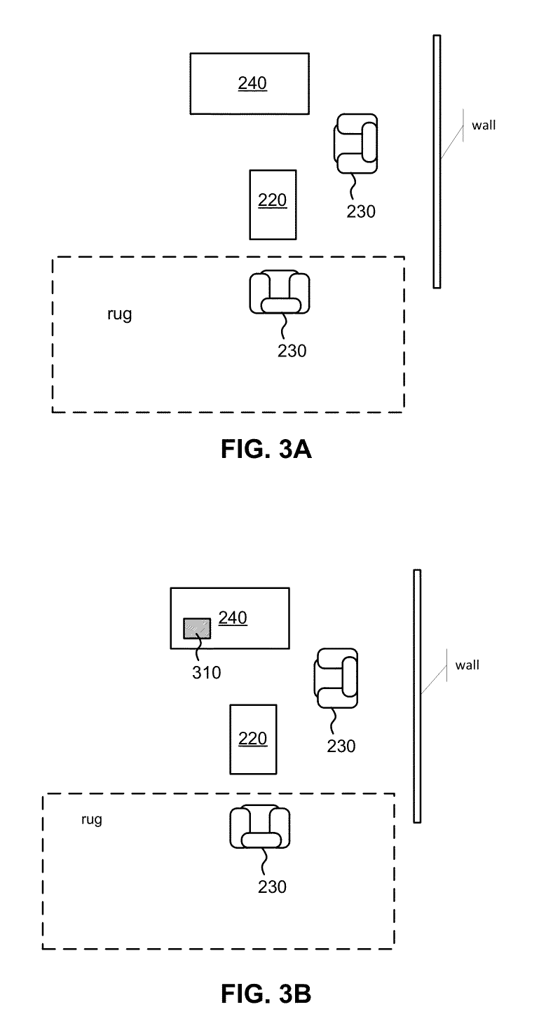

FIGS. 3A-6B illustrate embodiments of how IR images may be captured and processed for object identification and/or location in the area of a venue captured by the IR images. This information can further be used to create and/or update venue maps. As indicated previously, other embodiments may include visible and/or IR-like images, which can also be processed to determine the location and/or identity of objects. Image capture and/or processing techniques can vary from the embodiments shown. A person of ordinary skill in the art will recognize many substitutions, omissions, and/or other variations.

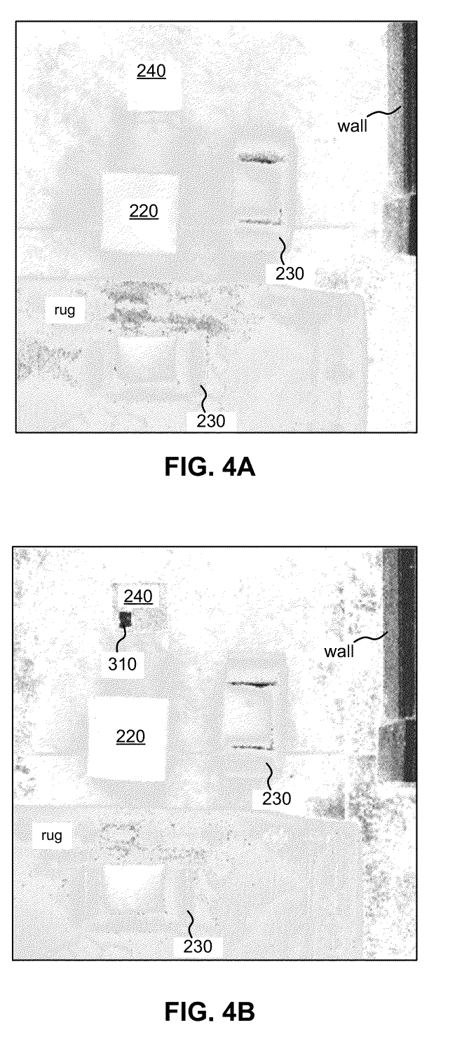

FIG. 3A represents a drawing (or map) of a subsection of a room. FIG. 3B represents the same room with an IR reflecting tag 310 on the book case 240. FIG. 4A is a representation of an IR image of the room that corresponds to FIG. 3A. And FIG. 4B is a representation of an IR image of the room that corresponds to FIG. 3B. (It can be noted that IR images are typically color images, but they are shown here in grayscale.) Note that the chairs 230, bookcase 240, and table 220 are approximately the same visible color as the tile flooring they were placed on. However, they show up as different colors under IR, because of their IR absorption characteristics. Also, note that the IR tag 310 (aluminum) was placed on the bookcase 240 in FIGS. 3B and 4B and shows up as a distinct square. (In the corresponding color IR image, the IR tag 310 appears red.)

Since IR is essentially a measure of heat, objects that reflect IR energy are colder than objects that absorb IR energy. For example, concrete is a fairly good absorber of heat (IR energy). It will be warmer than something on it that reflects heat (IR energy). For, example, an aluminum soda can on the side walk will reflect the heat and be cooler than the concrete. The warmer the object, the brighter it will appear on an IR image. Conversely the colder an object is, the darker it will appear on an IR image. Thus IR absorbers show up as bright objects, and IR reflectors show up as dark objects. In FIG. 4B, for example, the dark IR tag 310 and the wall are both IR reflectors and show up as dark colors in the image.

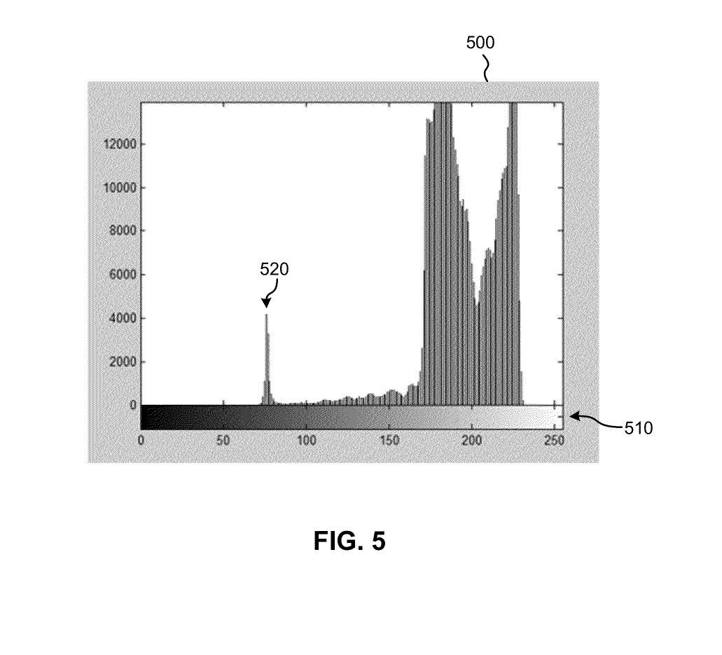

Once the images (e.g., images shown in FIGS. 4A-4B) are captured, image processing can be used to filter and detect the images to be able to obtain information from them that can be used to generate a venue map, or update an existing one. There are many image processing techniques known in the art. As way of example only, an IR image of FIG. 4B can be converted from color to grayscale. A histogram 500, shown in FIG. 5, can be obtained from the grayscale image.

The histogram 500 represents the volume of different gray shades, in pixels of the image of FIG. 4B. As shown by the x-axis scale 510, shades of gray get progressively lighter from left to right. The darkest shades in the image of FIG. 4B are around 75 on the x-axis scale. The spike 520 at 75 represents on the graph the dark IR tag 310 on the bookcase 240.

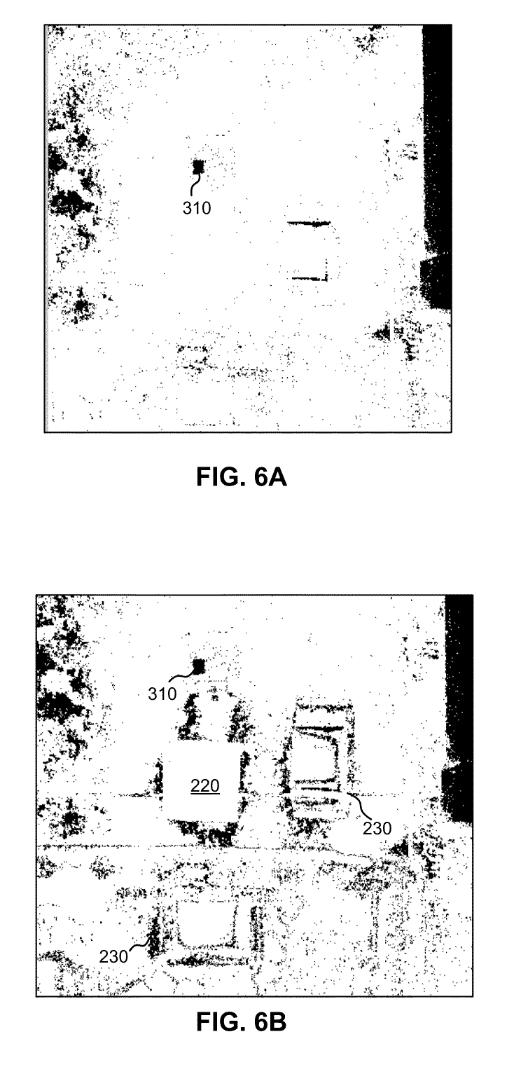

A threshold can be obtained from the histogram to know what to filter out of the image. The histogram threshold is used to create a black and white image to further facilitate object detection and/or identification. Shades of gray above the histogram threshold are converted to white, while shades below the histogram threshold are converted to black. FIG. 6A, for example, is a corresponding black and white conversion of the image of FIG. 4B in which a threshold level of 150 was used. Similarly, FIG. 6B is a corresponding black and white conversion of the image of FIG. 4B in which a histogram threshold level of 175 was used. The histogram thresholds can vary and filter out dark colors or light colors depending on which IR features one is trying to detect and/or the types of image processing used. In some embodiments, an image may be processed multiple times with multiple histogram thresholds. The processing can include smoothing filters such as Savitzky-Golay filter. Using IR images can make the image processing more efficient and less complicated. However, as indicated previously, it is possible to use images captured from regular cameras and process them as well.

For purposes of creating or updating a map, the image capture can occur at a certain time (or times) of the day when, for example, no people are present and thermal properties are predictable. Ambient temperatures may be controlled by an automatic thermostat setting. Moreover, image capture can use either the venue's own natural IR emissions from the objects in the area, and/or IR emitters may be placed in the area to enhance IR images. Here, and “IR emitter” is an item having a high emissivity value. A highly reflective item will have relatively low emissivity, while an item that reflects poorly will have relativity high emissivity, thereby making the poorly-reflecting item (i.e., an IR absorber) an “IR emitter.” More detail regarding thresholds for high and low reflectivity (e.g., low and high emissivity) is provided below.

Additional measures can be taken to facilitate image capture and processing for IR images. For example, certain paints that have specific IR thermal properties can be used on walls, shelves, or other objects. For example, paints with a reflective pigment, such as titanium dioxide, can provide objects with a characteristic reflective property. The wall shown in FIGS. 4A and 4B is “red” on the IR image (or dark in the corresponding grayscale images shown in FIGS. 4A and 4B) and is an example of an item painted with this reflective type paint. Thus, objects (or portions of objects) painted with thermally reflective paint can be easily distinguishable in IR images. Furthermore, surfaces coated in thermally reflective paint may be visibly similar in color to surfaces without thermally reflective paint, making objects easily distinguishable in IR images that may not be easily distinguishable in the visible spectrum.

Additionally or alternatively, other IR labels can be utilized. For example, stickers and/or other items attached to an object with an adhesive, symbols (which can comprise an emblem or insignia that is engraved, painted, attached, etc. to an object), tags and/or other items attachable to an object, emitters, and the like can be used, having IR characteristics tailored to be easily distinguishable from other objects in view of an IR camera. That is, these labels can be highly reflective, reflecting IR light at or above a certain threshold. The threshold for highly-reflective materials may vary, depending on the desired functionality of an embodiment. Such a threshold can be set at, for example, 75%, 80%, 85%, 90%, or 95% reflectivity. Other embodiments may have higher or lower thresholds. Similarly, IR labels may be highly absorptive, reflecting light below a certain threshold. As with highly-reflective labels, the reflectivity threshold for labels with low reflectivity can vary, depending on the desired functionality of the embodiment. For example, a threshold for low-reflective materials can be at or below 25%, 20%, 15%, 10%, or 5% reflectivity. Other embodiments may have higher or lower thresholds.

As indicated previously, knowing the IR emissivity characteristics of a material can help identify it. For example, a computer processing IR image data can compare measured emissivity and/or reflectivity values of one or more objects in the IR image data to a database of known emissivity and/or reflectivity values for different materials. For example, rather than simply determining that an object has an emissivity value of 0.95, a computer can compare this value with known emissivity values to determine the object is likely made out of wood. A computer may further include a database of objects having known emissivity and/or reflectivity values and/or made from certain known materials, thereby making the objects more easily identifiable from measured emissivity and/or reflectivity values.

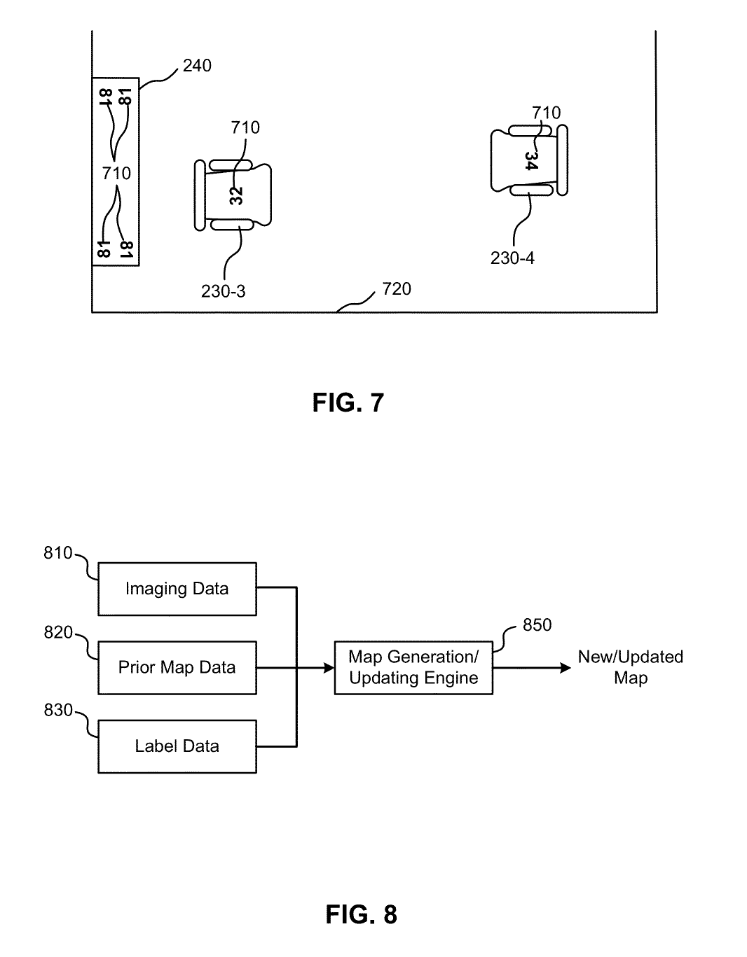

FIG. 4B shows how the usage of such labels may work. In FIG. 4B there is a reflecting IR tag 310 placed on top of the bookcase 240. These labels could be numbers, arrows, or any type of unique identifier that would enable identification of specific objects in the venue over others. For example, a bookcase that holds mystery novels in a book store could have a number associated with it. For example, say the mystery bookcase has “100” labeled IR tag on top of it. A table in the same store may have a circle sticker on it. These identifiable features may be associated with particular items, as described in more detail below in relation to FIG. 7.

Moreover, cameras may be configured to take images using multiple IR spectra. Additionally, the natural IR reflecting properties of known substances can be exploited. For example, aluminum reflects IR and is a low absorber. Some or all of these properties can be utilized in a system that is inexpensive and easy to install.

FIG. 7 illustrates the view of a portion of a room from a ceiling-mounted camera, providing an example of how IR labels can be used in some embodiments. In addition to the walls 720, the room has two chairs 230 and a bookcase 240. Additionally, the chairs 230 and bookcase 240 have labels 710 with an identifiable number on it: the bookcase 240 has the label “81,” and the chairs 230-3 and 230-4 have the labels “32” and “34” respectively. Although labels in this example are numerical, labels may additionally include symbols, emblems, graphics, and the like.

Labels can serve a variety of purposes. For one, labels can indicate an orientation of an object. For example, labels 710 on the chairs are oriented such that the bottom of the number faces the front of the chair. Thus, when images from the camera are processed and the orientation of the labels “32” and “34” is determined, the orientation of the chairs is also determined. That is, the chair 230-3 is determined to be facing the right because the bottom of its label “32” faces right. Similarly, the chair 230-4 is determined to be facing the left because the bottom of its label “34” faces right.

Different embodiments can utilize labels 710 in various manners. As illustrated by the bookcase 240, multiple labels 710 can be used to help increase the detectability of the labels 710 and/or facilitate the determination of the orientation of an object. In some embodiments, labels may also be unique, as indicated in FIG. 7, allowing for the identification of each object. In other embodiments, labels may identify groups of objects (e.g., all chairs—or all chairs of a certain type—may have the label “32”). A person of ordinary skill in the art will recognize many variations.

Labels 710 can also indicate characteristics of an object, which may be contained on a database hosted and/or accessible by a map server or other device processing the image data. For example, a computer may identify the label “32” while processing the example image of FIG. 7. The computer can then search database for object “32” to determine that the object is a chair 230-3 with certain physical dimensions. Depending on the accuracy of the embodiment, the dimensions may be in relation to the label such that the computer can determine the edges of the chair 230-3 in relation to the placement of the label 710.

FIG. 8 is a simplified input/output diagram illustrating how embodiments described herein can use an map generation/updating engine 850 to create a new or updated map based on imaging data 810, prior map data 820, and/or label data 830. Depending on the embodiment, additional factors may impact map generation and/or updating, and/or some of the illustrated components may be omitted. Here, the map generation/updating engine 850 can include any combination of hardware and/or software configured generate and/or update map data, such as the map data illustrated in FIG. 2. In some embodiments, the map generation/updating engine 850 may be executed by map server(s) 170 and/or location server(s) 160 of the positioning system 100 of FIG. 1.

Depending on the embodiment, imaging data 810 can comprise raw camera images or processed images. As indicated above, images can be captured at one or more designated times, such as times at which a person is not likely to be in an image and/or when little or no movement is taking place. Image capture can be scheduled and/or may be triggered by other events (e.g., the detection of no movement in the image). The frequency at which data is captured can also vary, depending on desired functionality. In some embodiments, images may be captured once a day. Other embodiments, however, can capture images hourly, every other day, weekly, etc. Imaging data may also include additional information an image, such as a location where the image was taken, and angle or field of view of the image, and the like, enabling the map generation/updating engine 850 to compensate for these factors when using data from images to generate or update a map. Additionally or alternatively, new images may be compared with previously-captured images to determine what changes, if any, have taken place.

If the map generation/updating engine 850 is updating an existing map, prior map data 820 can be used. The prior map data 820 can be stored by a device; for example, in the memory the map server(s) 170 of FIG. 1. Depending on desired functionality, embodiments may wait to generate a new or updated map feature until the feature has been verified multiple times in the imaging data 810. For example, the movement of a shelving unit in a retail store may not be reflected in the map data of the store for a day or so, to help ensure the change is permanent. Other embodiments may update map data to reflect changes as soon as they are detected.

As indicated above in reference to FIG. 7, the map generation/updating engine 850 can also use label data 830 in the generation and/or creation of a map. Label data 830 can include information regarding objects associated with labels, such as the dimensions and/or orientation of the objects. The label data 830 may be stored in a database and hosted by the same device(s) executing the map generation/updating engine 850. Other embodiments may store the label data 830 remotely.

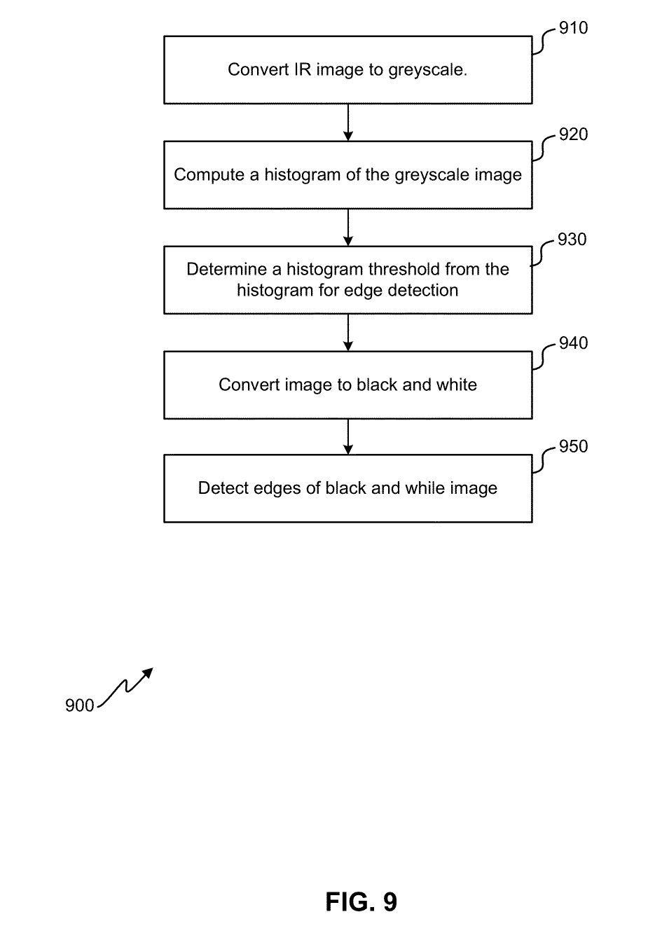

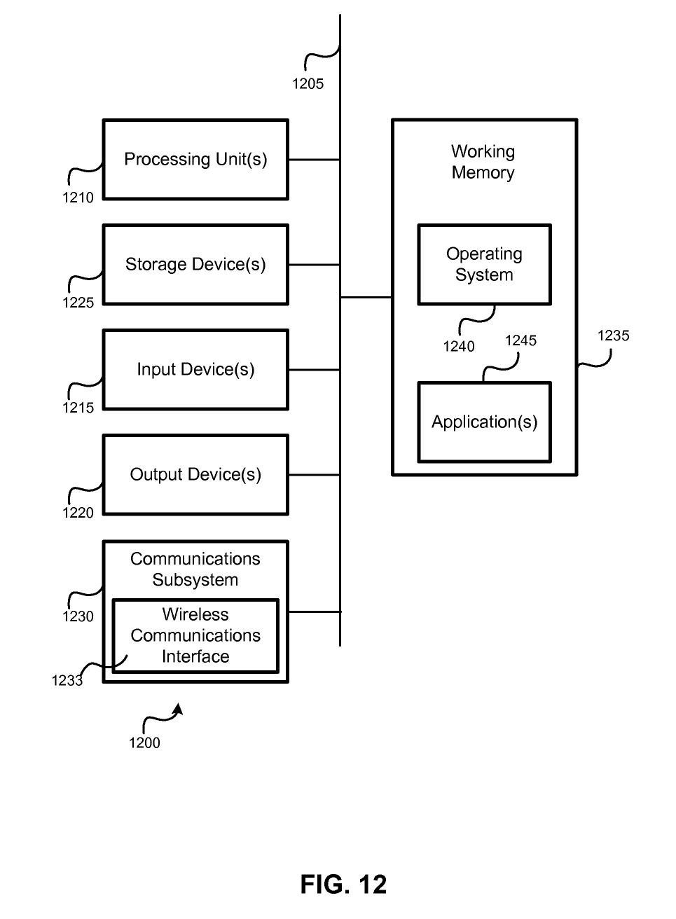

Camera images can be processed in any of a variety of ways to determine the location of objects on a map, depending on desired functionality. FIG. 9 is a flow chart of a method 900 for processing an IR image, according to one embodiment. The method 900 can be executed by location server(s) 160, map server(s) 170, and/or other device(s). More specifically, means for performing some or all components shown in FIG. 9 can include, for example, specialized and/or generalized hardware programmed and/or otherwise configured to perform the components shown. An example computer system with such means is described in further detail below with regard to FIG. 12. As with other embodiments described herein, the method 900 can be extended to non-IR images, such as images of the visible light spectrum. The method 900 generally follows the steps illustrated in FIGS. 3A-6B.

The method 900 can begin at block 910, where an IR image is converted to greyscale. At block 920, a histogram of the greyscale image is then computed. The histogram can represent a number of pixels for each shade in the grayscale image, from darkest to lightest. Both the greyscale image and the histogram can be created using commonly-known techniques.

At block 930, a threshold for edge detection is determined from the histogram. This histogram threshold can be used to determine which levels of gray are converted to black, and which levels are converted to white when the image is subsequently converted from greyscale to black and white. Histogram thresholds can be chosen using any of a variety of known methods. Methods for choosing a histogram threshold can depend on a distribution depicted in the histogram (e.g., choosing a threshold to include or exclude a prominent feature in the histogram). In general, a histogram threshold can be chosen so that the lightest 25% to 50% of pixels are converted to white, while the remaining pixels are converted to black. That said, embodiments may utilize histogram thresholds outside this range. Furthermore, processing of a single image may involve executing some or all of the components of the method 900 several times, in which different histogram thresholds may be used. Once a histogram threshold is chosen, the image is converted to black and white, at block 940.

At block 950, edges in the black and white image are detected. As with other image processing algorithms described herein, edge detection can be employed using any of a variety of known techniques. Once edges are determined, an object's dimensions and/or label can be determined, and the map can be updated accordingly by, for example, the map generation/updating engine 550 of FIG. 8.

It should be appreciated that the specific steps illustrated in FIG. 9 provide an example method 900 for processing an IR image, according to one embodiment. Alternative embodiments may include alterations to the embodiments shown. Furthermore, additional features may be added or removed depending on the particular applications. For example, embodiments may include further processing, such as mathematical transforms, mapping, and the like, to compensate for various angles views with which IR images are taken. (E.g., an image from a camera mounted on a wall taken at an angle can be processed differently than and image from a ceiling-mounted camera, to compensate for the different viewpoints.) One of ordinary skill in the art would recognize many variations, modifications, and alternatives.

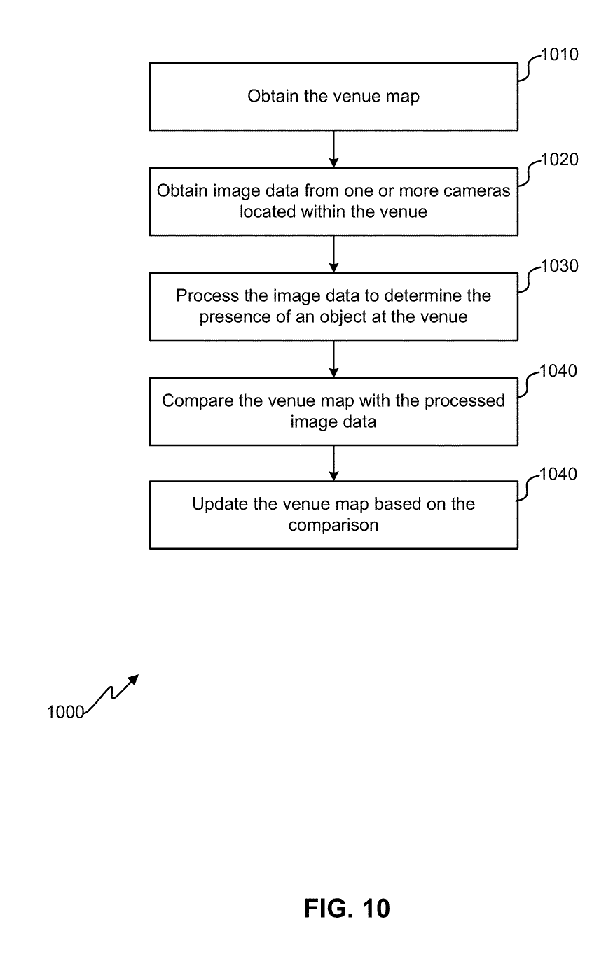

FIG. 10 is a flow diagram of a method 1000 for updating a venue map, according to one embodiment. The method 1000 can be executed by a map generation/updating engine 550 as shown in FIG. 8, which can run on the hardware of a server or other computing device, such as the map server(s) 170 of FIG. 1. More generally, means for performing some or all components shown in FIG. 10 can include, for example, specialized and/or generalized hardware programmed and/or otherwise configured to perform the components shown. Such means are described in further detail below with regard to FIG. 12.

The method 1000 can begin at block 1010 by obtaining the venue map. Depending on the desired functionality, the venue map may be stored on in a memory of any of a variety of devices, such as the location server(s) 160 of FIG. 1. The memory may be remote from and/or local to one or more devices performing one or more of the components of the method 1000.

At block 1020, data from one or more cameras located within the venue is obtained. As indicated previously herein, images can include IR and/or visible-light images. In some embodiments, images may include a plurality of IR spectra (e.g., short-wavelength IR and long-wavelength IR), which can facilitate the detection of different objects and/or object features.

At block 1030, image data is processed to determine the presence of an object at the venue. The image may be processed using any of a variety of techniques, including some or all of the components of the method 900 of FIG. 9. As indicated previously, additional steps (e.g., mathematical transforms and/or other types of mapping) can be taken to determine a detected object's location with regard to the building and/or map.

As indicated previously determining the presence of an object may vary, depending on desired functionality. For example, when analyzing an image (and, in particular, and IR image), the analysis can include a determination of one or more patterns indicative of an object that reflects IR light above a certain threshold (e.g., appears bright in an IR image), and/or an object that reflects IR light below a certain threshold (e.g., appears dark in an IR image). Detectable objects and items can include labels such as stickers, insignias, emblems, tags, and the like, and/or IR emitters, paint, structural component, and/or furnishings of the building. Some embodiments may not only determine the presence of an object, but also identify the object. Furthermore, where the object is a label (or other identifying feature), the identity, orientation, and/or other features of a structural component or furnishing can be determined based on the identity and/or orientation of the label.

With the object (and object's location) determined, the venue map can be compared with the processed image data, at block 1040. This comparison can reveal, for example, that a position of the object has changed, and/or that the object is not present in the venue map. Based on the comparison, the venue map can be updated, at block 1050. This newly-updated venue map can then be sent to a mobile device for positioning within the venue and/or other functions.

It should be appreciated that the specific steps illustrated in FIG. 10 provide an example method 1000 for updating a venue map. Alternative embodiments may include alterations to the embodiments shown. Furthermore, additional features may be added or removed depending on the particular applications. Venues may vary, and may include indoor locations, outdoor locations, or both. One of ordinary skill in the art would recognize many variations, modifications, and alternatives.

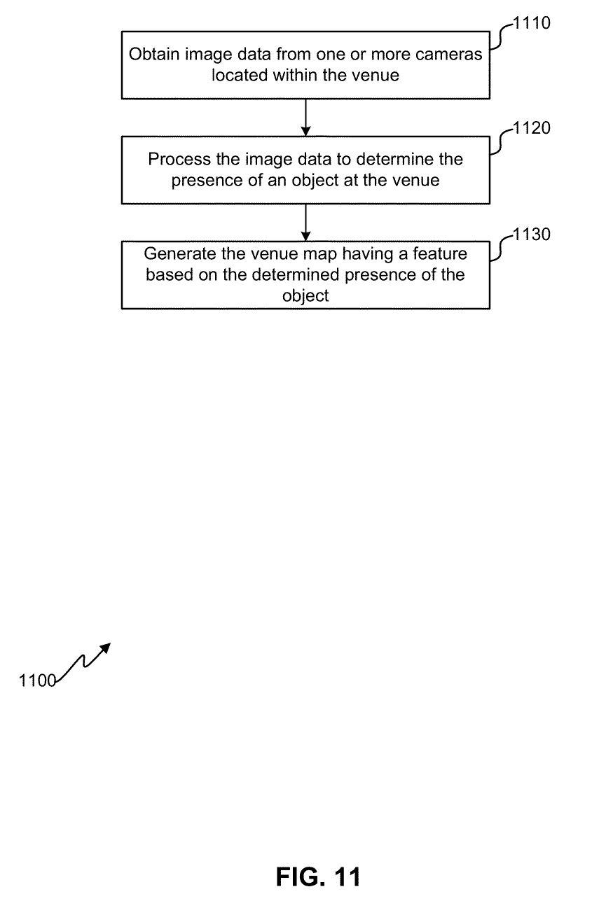

FIG. 11 illustrates is a flow diagram of a method 1100 for generating a venue map, according to one embodiment. Similar to the method 1000 of FIG. 10, the method 1100 of FIG. 11 can be executed by a map generation/updating engine 550 as shown in FIG. 8, or by other means. More generally, means for performing some or all components shown in FIG. 11 can include, for example, specialized and/or generalized hardware programmed and/or otherwise configured to perform the components shown. Such means are described in further detail below with regard to FIG. 12.

Blocks 1110 and 1120 echo similar blocks 1020 and 1030 in FIG. 10. Again, image data can comprise data from visible-light and/or IR cameras located within the venue. Here, however, a venue map is generated based on the determined presence of an object, at block 1130. Depending on desired functionality, the venue map may be generated using solely image data from the one or more cameras located within the venue. In other embodiments, the venue map generation may be based on one or more additional sources, such as blueprint and/or other structural data regarding a venue and/or information regarding objects within the venue.

It should be appreciated that the specific steps illustrated in FIG. 11 provide an example method 1100 for generating a venue map. Alternative embodiments may include alterations to the embodiments shown. Furthermore, additional features may be added or removed depending on the particular applications. One of ordinary skill in the art would recognize many variations, modifications, and alternatives.

FIG. 12 illustrates an embodiment of a computer system 1200, which may be incorporated, at least in part, into devices such the access point(s) 130, location server(s) 160, map server(s) 170 of FIG. 1. FIG. 12 provides a schematic illustration of one embodiment of a computer system 1200 that can perform the methods provided by various other embodiments, such as the methods described in relation to FIGS. 9-11. It should be noted that FIG. 12 is meant only to provide a generalized illustration of various components, any or all of which may be utilized as appropriate. FIG. 12, therefore, broadly illustrates how individual system elements may be implemented in a relatively separated or relatively more integrated manner. In addition, it can be noted that components illustrated by FIG. 12 can be localized to a single device and/or distributed among various networked devices, which may be disposed at different physical locations.

The computer system 1200 is shown comprising hardware elements that can be electrically coupled via a bus 1205 (or may otherwise be in communication, as appropriate). The hardware elements may include processing unit(s) 1210, which can include without limitation one or more general-purpose processors, one or more special-purpose processors (such as digital signal processing chips, graphics acceleration processors, and/or the like), and/or other processing structure, which can be configured to perform one or more of the methods described herein, including the methods illustrated in FIGS. 9-11. The computer system 1200 also can include one or more input devices 1215, which can include without limitation a mouse, a keyboard, a camera, a microphone, other biometric sensors, and/or the like; and one or more output devices 1220, which can include without limitation a display device, a printer, and/or the like.

The computer system 1200 may further include (and/or be in communication with) one or more non-transitory storage devices 1225, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 1200 might also include a communications subsystem 1230, which can include wireless communication technologies managed and controlled by a wireless communication interface 1233, as well as wired technologies. As such, the communications subsystem can include a modem, a network card (wireless or wired), an infrared communication device, a wireless communication device, and/or a chipset (such as a Bluetooth device, an IEEE 802.11 device, an IEEE 802.15.4 device, a WiFi device, a WiMax device, cellular communication facilities, UWB interface, etc.), and/or the like. The communications subsystem 1230 may include one or more input and/or output communication interfaces, such as the wireless communication interface 1233, to permit data to be exchanged with a network, mobile devices, other computer systems, and/or any other electronic devices described herein.

In many embodiments, the computer system 1200 will further comprise a working memory 1235, which can include a RAM or ROM device, as described above. Software elements, shown as being located within the working memory 1235, can include an operating system 1240, device drivers, executable libraries, and/or other code, such as one or more application programs 1245, which may comprise computer programs provided by various embodiments, and/or may be designed to implement methods, and/or configure systems, provided by other embodiments, as described herein. Merely by way of example, one or more procedures described with respect to the method(s) discussed above, such as the method described in relation to FIGS. 9-11, might be implemented as code and/or instructions executable by a computer (and/or a processing unit within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1225 described above. In some cases, the storage medium might be incorporated within a computer system, such as computer system 1200. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1200 and/or might take the form of source and/or installable code, which, upon compilation and/or installation on the computer system 1200 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 1200) to perform methods in accordance with various embodiments of the invention. According to a set of embodiments, some or all of the procedures of such methods are performed by the computer system 1200 in response to processor 1210 executing one or more sequences of one or more instructions (which might be incorporated into the operating system 1240 and/or other code, such as an application program 1245) contained in the working memory 1235. Such instructions may be read into the working memory 1235 from another computer-readable medium, such as one or more of the storage device(s) 1225. Merely by way of example, execution of the sequences of instructions contained in the working memory 1235 might cause the processor(s) 1210 to perform one or more procedures of the methods described herein. Additionally or alternatively, portions of the methods described herein may be executed through specialized hardware.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

What is claimed is:

1. A method of updating a venue map, the method comprising:
obtaining the venue map;
obtaining image data from one or more cameras located within the venue;
processing the image data to determine the presence of an object at the venue;
comparing, with a processor, the venue map with the processed image data; and
updating the venue map based on the comparison.

2. The method of claim 1, wherein the image data is from one or more infrared (IR) cameras.

3. The method of claim 1, wherein the image data is from one or more camera images of visible light.

4. The method of claim 2, wherein processing the image data includes determining one or more patterns indicative of either or both:
an item that reflects IR radiation above a certain threshold or,
an item that reflects IR radiation below a certain threshold.

5. The method of claim 1, wherein the object includes at least one of:
a sticker,
paint,
a symbol,
an IR absorber,
an IR reflector, or
a tag.

6. The method of claim 1, further comprising determining the object is attached to a structural component or furnishing of the venue.

7. The method of claim 6, further comprising identifying the object.

8. The method of claim 7, further comprising determining an orientation of the structural component or furnishing based on an orientation of the object.

9. The method of claim 7, further comprising determining one or more features of the structural component or furnishing based on information corresponding to the object.

10. The method of claim 1, wherein the object comprises a structural component or furnishing.

11. The method of claim 1, further comprising sending the venue map to a mobile device.

12. A server comprising:
a communication interface;
a memory; and
a processing unit communicatively coupled with the memory and the communication interface, and configured to perform functions including:
obtaining a venue map;
obtaining image data from one or more cameras located within the venue;
processing the image data to determine the presence of an object at the venue;
comparing the venue map with the processed image data; and
updating the venue map based on the comparison.

13. The server of claim 12, wherein the processing unit is configured to obtain the image data from one or more visible light cameras.

14. The server of claim 12, wherein the processing unit is configured to obtain the image data from one or more infrared (IR) cameras.

15. The server of claim 14, wherein the processing unit is configured to process the image data by determining one or more patterns indicative of either or both:
an item that reflects IR light above a certain threshold or,
an item that reflects IR light below a certain threshold.

16. The server of claim 12, wherein the processing unit is configured to determine the presence of an object by determining the presence of at least one of:
a sticker,
paint,
a symbol,
an IR emitter, or
a tag.

17. The server of claim 12, wherein the processing unit is further configured to determine the object is attached to a structural component or furnishing of the venue.

18. The server of claim 17, wherein the processing unit is further configured to identify the object.

19. The server of claim 18, wherein the processing unit is further configured to determine an orientation of the structural component or furnishing based on an orientation of the object.

20. The server of claim 18, wherein the processing unit is further configured to determine one or more features of the structural component or furnishing based on information corresponding to the object.

21. The server of claim 12, wherein the processing unit is configured to determine the presence of an object by determining the presence of a structural component or furnishing.

22. A computer-readable storage medium having instructions embedded thereon for updating a venue map, the instructions including computer-executable code for:
obtaining the venue map;
obtaining image data from one or more cameras located within the venue;
processing the image data to determine the presence of an object at the venue; and
updating the venue map based on the comparison.

23. The computer-readable storage medium of claim 22 wherein the code for processing the image data comprises code for processing image data from one or more visible-light cameras.

24. The computer-readable storage medium of claim 22 wherein the code for processing the image data comprises code for processing image data from one or more infrared (IR) cameras.

25. The computer-readable storage medium of claim 24, wherein the code for processing the image data includes code for determining one or more patterns indicative of either or both:
an item that reflects IR light above a certain threshold or,
an item that reflects IR light below a certain threshold.

26. The computer-readable storage medium of claim 22, wherein the code for determining the presence of an object includes code for determining the presence of at least one of:
a sticker,
paint,
a symbol,
an IR emitter, or
a tag.

27. The computer-readable storage medium of claim 22, further comprising code for determining the object is attached to a structural component or furnishing of the venue.

28. The computer-readable storage medium of claim 27, further comprising code for identifying the object.

29. The computer-readable storage medium of claim 28, further comprising code for determining an orientation of the structural component or furnishing based on an orientation of the object.

30. The computer-readable storage medium of claim 28, further comprising code for determining one or more features of the structural component or furnishing based on information corresponding to the object.

31. The computer-readable storage medium of claim 22, wherein the code for determining the presence of an object comprises code for determining the presence of a structural component or furnishing.

32. The computer-readable storage medium of claim 22, further comprising code for sending the venue map to a mobile device.

33. A device comprising:
means for obtaining a venue map;
means for obtaining image data from one or more cameras located within the venue;
means for processing the image data to determine the presence of an object at the venue;
means for comparing the venue map with the processed image data; and
means for updating the venue map based on the comparison.

34. The device of claim 33, wherein the means for processing the image data comprise means for processing image data from one or more visible-light cameras.

35. The device of claim 33, wherein the means for processing the image data comprise means for processing image data from one or more infrared (IR) cameras.

36. The device of claim 35, wherein the means for processing the image data includes means for determining one or more patterns indicative of either or both:
an item that reflects IR light above a certain threshold or,
an item that reflects IR light below a certain threshold.

37. The device of claim 33, wherein the means for determining the presence of an object include means for determining the presence of at least one of:
a sticker,
paint,
an insignia,
an emblem,
an IR emitter, or
a tag.

38. The device of claim 33, further comprising means for determining the object is attached to a structural component or furnishing of the venue.

39. The device of claim 38, further comprising means for identifying the object.

40. The device of claim 39, further comprising means for determining an orientation of the structural component or furnishing based on an orientation of the object.

41. The device of claim 39, further comprising means for determining one or more features of the structural component or furnishing based on information corresponding to the object.

42. The device of claim 33, further comprising means for determining the object comprises a structural component or furnishing.

43. The device of claim 33, further comprising means for sending the venue map to a mobile device.

44. A method of generating a venue map, the method comprising:
obtaining image data from one or more cameras located within the venue;
processing the image data to determine the presence of an object at the venue; and
generating, with a processor, the venue map having a feature based on the determined presence of the object.

45. The method of claim 44, wherein the image data is from one or more camera images of visible light.

46. The method of claim 44, wherein the image data is from one or more infrared (IR) cameras.

47. The method of claim 44, wherein the object includes at least one of:
a sticker,
paint,
an insignia,
an emblem,
an IR emitter, or
a tag.

48. The method of claim 44, further comprising determining the object is attached to a structural component or furnishing of the venue.

49. The method of claim 48, further comprising identifying the object.

50. The method of claim 49, further comprising determining an orientation of the structural component or furnishing based on an orientation of the object.

51. The method of claim 49, further comprising determining one or more features of the structural component or furnishing based on information corresponding to the object.

52. The method of claim 44, wherein the object comprises a structural component or furnishing.

53. The method of claim 44, further comprising sending the venue map to a mobile device.

54. A server comprising:
a communication interface;
a memory; and
a processing unit communicatively coupled with the memory and the communication interface, and configured to perform functions including:
obtaining image data from one or more cameras located within a venue;
processing the image data to determine the presence of an object at the venue; and
generating the venue map having a feature based on the determined presence of the object.

55. The server of claim 54, the processing unit is configured to obtain the image data from one or more visible light cameras.

56. The server of claim 54, wherein the processing unit is configured to obtain the image data from one or more infrared (IR) cameras.

57. The server of claim 54, wherein the processing unit is configured to determine the presence of an object by determining the presence of at least one of:
a sticker,
paint,
an insignia,
an emblem,
an IR emitter, or
a tag.

58. The server of claim 54, wherein the processing unit is further configured to determine the object is attached to a structural component or furnishing of the venue.

59. The server of claim 58, wherein the processing unit is further configured to identify the object.

60. The server of claim 59, wherein the processing unit is further configured to determine an orientation of the structural component or furnishing based on an orientation of the object.

61. The server of claim 59, wherein the processing unit is further configured to determine one or more features of the structural component or furnishing based on information corresponding to the object.

62. The server of claim 54, wherein the object comprises a structural component or furnishing.

63. The server of claim 54, wherein the processing unit is further configured to send the venue map to a mobile device via the communication interface.

64. A computer-readable storage medium having instructions embedded thereon for generating a venue map, the instructions including computer-executable code for:
obtaining image data from one or more cameras located within a venue;
processing the image data to determine the presence of an object at the venue; and
generating the venue map having a feature based on the determined presence of the object.

65. The computer-readable storage medium of claim 64, wherein the code for processing the image data comprises code for processing image data from one or more visible-light cameras.

66. The computer-readable storage medium of claim 64, wherein the code for processing the image data comprises code for processing image data from one or more infrared (IR) cameras.

67. The computer-readable storage medium of claim 64, wherein the code for determining the presence of an object comprises code for determining the presence of at least one of:
a sticker,
paint,
an insignia,
an emblem,
an IR emitter, or
a tag.

68. The computer-readable storage medium of claim 64, further comprising code for determining the object is attached to a structural component or furnishing of the venue.

69. The computer-readable storage medium of claim 68, wherein further comprising code for identifying the object.

70. The computer-readable storage medium of claim 69, further comprising code for determining an orientation of the structural component or furnishing based on an orientation of the object.

71. The computer-readable storage medium of claim 69, further comprising code for determining one or more features of the structural component or furnishing based on information corresponding to the object.

72. The computer-readable storage medium of claim 64, wherein the object comprises a structural component or furnishing.

73. The computer-readable storage medium of claim 64, further comprising code for sending the venue map to a mobile device.

74. A device comprising:
means for obtaining image data from one or more cameras located within a venue;
means for processing the image data to determine the presence of an object at the venue; and
means for generating the venue map having a feature based on the determined presence of the object.

75. The device of claim 74, wherein the means for processing the image data comprises means for processing image data from one or more visible-light cameras.

76. The device of claim 74, wherein the means for processing the image data comprises means for processing image data from one or more infrared (IR) cameras.

77. The device of claim 74, wherein the means for processing the image data to determine the presence of an object comprises means for determining the presence of at least one of:
a sticker,
paint,
an insignia,
an emblem,
an IR emitter, or
a tag.

78. The device of claim 74, further comprising means for determining the object is attached to a structural component or furnishing of the venue.

79. The device of claim 78, wherein further comprising means for identifying the object.

80. The device of claim 79, further comprising means for determining an orientation of the structural component or furnishing based on an orientation of the object.

81. The device of claim 79, further comprising means for determining one or more features of the structural component or furnishing based on information corresponding to the object.

82. The device of claim 74, wherein the object comprises a structural component or furnishing.

83. The device of claim 74, further comprising means for sending the venue map to a mobile device.
